(19) United States
(12) Patent Application Publication
(10) Pub. No.: US 2006/0062977 A1
(43) Pub. Date: Mar. 23, 2006

(54) Bonded lightweight structural sheet

(76) Inventors: David R. Sigler, Shelby Township, MI (US); James G. Schroth, Troy, MI (US); Xiaohong Q. Gayden, West Bloomfield, MI (US)

Correspondence Address: KATHRYN A. MARRA;General Motors Corporation, Legal Staff, Mail Code 482-C23-B21, P.O. Box 300, Detroit, MI, 48265-3000, US

(21) Appl. No.: 11/155,180

(22) Filed: Jun. 17, 2005

Related U.S. Application Data
(63) Continuation-in-part of application No. 10/946,701, filed on Sep. 22, 2004.

(51) Int. Cl. B32B 3/00; B32B 5/16; B32B 9/04

(52) U.S. Cl. 428/209; 428/323; 428/446; 428/704

(57) ABSTRACT

Laminated composites such as noise damping sheet metal sandwiches with viscoelastic adhesive cores are strengthened against delamination during forming and made more conductive for welding. Electrically conductive, metal-element containing particles, wires, wire meshes, or the like conductive bonding elements are included in the core material and fused to facing surfaces of the metal sheets to provide many mechanical bonding connections and electrical connections over the bonded area of the composites.

This application is a continuation-in-part of co-pending U.S. application Ser. No. 10/946,701, filed Sep. 22, 2004, (docket number GP-304448), titled “Conductive Adhesive Bonding.”

### TECHNICAL FIELD

This invention pertains generally to making lightweight laminated structural panels that have sound damping capability. More specifically, this invention relates to sound damping panels having improved resistance to delamination and with improved electrical conductivity.

### BACKGROUND OF THE INVENTION

Sandwich-type composites with a thin viscoelastic material layer between two metal sheets are used to damp noise and vibration in automotive vehicle components and other products. The facing metal sheets provide structural integrity and the interposed viscoelastic material provides sound and/or vibration attenuation and adhesion between the sheets. The viscoelastic material is often formulated from acrylic polymers, epoxy polymers, and copolymers.

Such composites are often initially prepared as rolled coils of laminated flat sheets. However, in use, blanks of the laminated sheet material are then stamped or otherwise formed into a three-dimensional configuration for welding into a vehicle body structure. Such forming operations tend to cause the bonded sheets to delaminate, which can compromise both damping performance and structural performance of the dash, plenum, oil pan, or the like. Moreover, the viscoelastic material is often inherently an electrical insulator, a property that impedes resistance welding of the metal laminate into an assembly with other members.

It is an object of this invention to provide a more durable mechanical and adhesive bond between the metal sheets of the sound damping laminate. The bond includes many discrete mechanical and electrical connections through the viscoelastic adhesive and between the sheets of the metal.

### SUMMARY OF THE INVENTION

A suitable viscoelastic adhesive composition is applied to at least one of the facing surfaces of the metal sheets to bond them together in the vibration and sound damping laminate. As applied to the metal sheet(s), the viscoelastic adhesive contains electrically conductive bonding elements such as particles, wires, or wire mesh that will melt below the melting point of the sheets and wet their surfaces. The particles or other bonding elements are sized to span the desired adhesive thickness and contact both metal sheets. As the sheets are pressed together with the adhesive between them, the bonding elements are momentarily melted either partially or entirely to wet the sheet metal faces and to form, on re-solidification, many conductive and mechanical bonding pathways between the sheets. Sufficient non-bonded area remains between the sheets for the damping effect of the adhesive.

In addition to its viscoelastic properties for sound deadening, the adhesive is selected to be applicable to and compatible with the metal sheet material and the intended operating environment of the laminate structure. For example, acrylic polymers, epoxy polymers, and copolymers and mixtures are used in such applications. The viscoelastic adhesive core contains conductive particles, wires, wire meshes, or like bonding elements that are in contact with the sheets and are used to provide mechanical connections and electrical conductivity between the facing surfaces of the metal sheets. (For brevity, the term particles will hereafter generally be used in this specification to include other conductive elements such as wires and meshes) For example, the conductive particles are suitably composed of metal alloys or intermetallic compounds. Preferably, the conductive particles are relatively low-melting in close contact with the workpieces. As the adhesive coated sheets are pressed together to compress and distribute the adhesive film, the particles bridging the adhesive filled gap are either partially or completely fused by passing an electric current between the workpieces. The molten droplets wet the facing surfaces and depending on the substrate composition, particle composition, and level of current passed through the workpieces, localized melting of the substrate occurs to increase the size of the molten droplet. Removing the current flow causes the droplets to re-solidify into many small mechanical and electrically conductive columns or links through the adhesive between the sheets. Once these links are established, the adhesive is also separately heated to promote flow between the sheets and, if necessary, to cure it.

Thus, the selection of the conductive particles (elements) normally depends on the sheet metal material of the laminate. For example, when ferrous metal sheets are to be bonded, nickel-phosphorus particles or alloy particles from compositional systems that form alloys with iron, such as the iron-phosphorus, iron-carbon or iron-silicon systems are suitable. The alloys may be eutectic alloys. Either nickel-phosphorus or the ferrous alloys or intermetallics are susceptible to melting, wetting and flowing against steel sheet material. After wetting the facing sheet surfaces, the metallic element containing droplets re-solidify to form many conductive paths from sheet to sheet and decrease the electrical resistance inherent in the adhesive bond.

When the laminate sheets are made of aluminum; aluminum-silicon particles, especially silicon-rich aluminum alloy particles, are suitable for wetting and providing good mechanical and electrical connections between the touching sheet portions.

The metal particles, wires, or mesh elements are proportioned with adhesive in an amount to provide a suitable number of mechanical and electrical connections per unit area of the facing metal sheets. In the case of particle-containing adhesive, it is applied to one or both of facing sheets and the particles are spread more or less uniformly between the sheets when they are pressed together. In the case of chopped wires, wire loops, or wire meshes, these bonding elements could be spread onto one sheet and covered with applied adhesive, or placed on or in an adhesive coated surface. During bonding, for example roll bonding, of the sheets the many discrete mechanical and electrical connections are formed between the facing surfaces.

Other objects and advantages of the invention will become apparent from a detailed description of preferred embodiments which follow.

### BRIEF DESCRIPTION OF THE DRAWINGS

FIG. 1 is an isometric view of a partly unrolled coil of sheet metal-viscoelastic laminate that is partly broken away and in section to illustrate the metal columns connecting the facing surfaces of the sheets through the adhesive layer when conductive particles are incorporated in the adhesive.

FIG. 2 is a schematic side elevational view illustrating roller equipment for a method of continuously applying a coating of the conductive-connective particle-containing adhesive to facing surfaces of the sheet layers, pressing adhesive coated surfaces between rollers, and passing a current between the adhesive coated sheets to fuse conductive particles in the adhesive into conductive and bonding links between the sheets.

FIG. 3A is a cross-section of a fragment of the adhesive coated sheets showing the conductive particles before they are fused.

FIG. 3B is a cross-section of a fragment of the adhesive bonded sheets showing the conductive particles after they are fused.

FIG. 4A is an isometric and fragmentary view of a partly unrolled coil of sheet metal-viscoelastic laminate that is partly broken away and in section to illustrate the use of a wire mesh for connecting the facing surfaces of the sheets through the adhesive layer.

FIG. 4B is an isometric and fragmentary view of a partly unrolled coil of sheet metal-viscoelastic laminate that is partly broken away and in section to illustrate the use of chopped wires for connecting the facing surfaces of the sheets through the adhesive layer.

### DESCRIPTION OF A PREFERRED EMBODIMENT

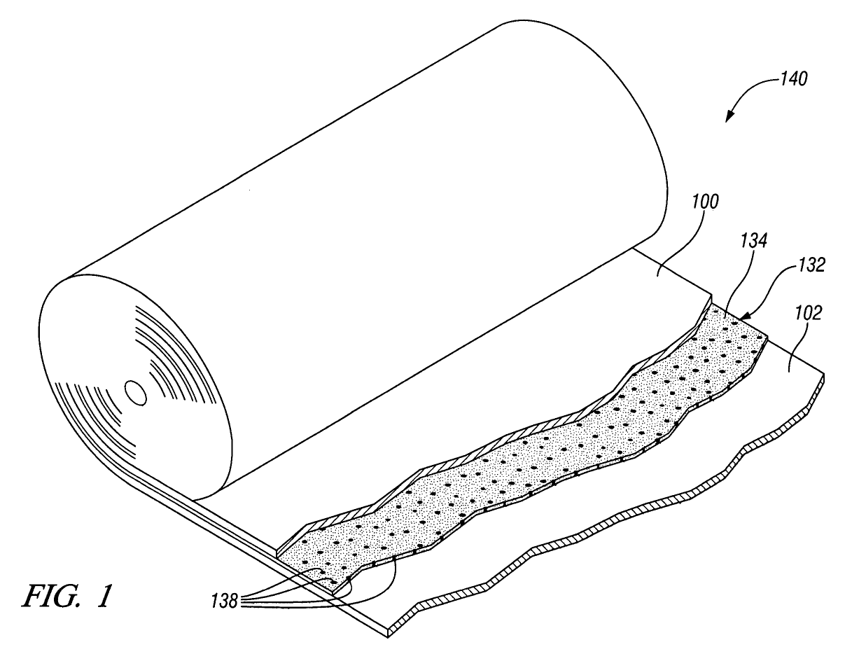

FIG. 1 illustrates a first embodiment of the invention in which uniformly-sized electrically conductive particles are used to form many columnar mechanical links between metal sheets in a three layer, sound deadening laminate of sheet metal, viscoelastic polymer adhesive, and sheet metal.

FIG. 1 shows a partly unwound coil of a sound-deadening, laminated sheet metal material 140. The laminate material 140 comprises two facing metal sheets 100 and 102 that are bonded together by an interfacial core layer 132. Core layer 132 includes a suitable viscoelastic polymeric adhesive material 134 that separates and adhesively bonds to facing surfaces of metal sheets 100, 102. Core layer 132 also includes many small diameter particulate bonding elements 138 distributed generally uniformly in the surrounding adhesive material 134 and that span the thickness of the viscoelastic core layer 132. During the fabrication of the laminate material 140, opposing sides of the particulate bonding elements 138 are welded to locations on facing surfaces of metal sheets 100, 102. These particulate bonding elements 138 are formed, as described below, from particles 136 (FIGS. 3A and 3B) initially dispersed in the adhesive 134. The particles are of generally uniform size and are suitably formed of metal, metal alloy, or an electrically conductive intermetallic compound. The many conductive particulate bonding elements 138 provide mechanical and electrical connections between the metal sheets 100, 102.

As will be described in illustrating a preferred method of making the sound-deadening laminate, the mechanically connective and electrically conductive columns are formed from suitable metal-element containing particles included in the formulation of the viscoelastic polymeric material. The particle containing adhesive material is applied to one or both facing surfaces of the metal sheets and the sheets are bonded together. The particles are bonded to the sheets, for example, by passage of an electrical current between the sheets to fuse surfaces of the particles to both sheets to make many electrical and mechanical connections per unit area of the facing sheets. The particles are sized to span the desired adhesive-filled gap (or spacing) of uniform thickness between the metal sheets.

The compositions, thicknesses, and widths of the facing sheets will usually, but not necessarily, be the same. The thickness of each metal sheet is, for example, in the range of 0.1 mm to about 1.5 mm. Typically, each sheet will be of a formable steel or aluminum alloy composition depending upon the vehicle body portion or other article of manufacture into which the sound-deadening or damping laminate is to be assembled. In many applications, a suitable workpiece portion (blank) of laminate material is provided such as by cutting it from a coil of the laminate. The blank is preformed to serve its function and the preform welded into an intended assembly. Thus, the laminate must often be formable without delamination, and have suitable electrical conductivity through its viscoelastic core layer for resistance welding.

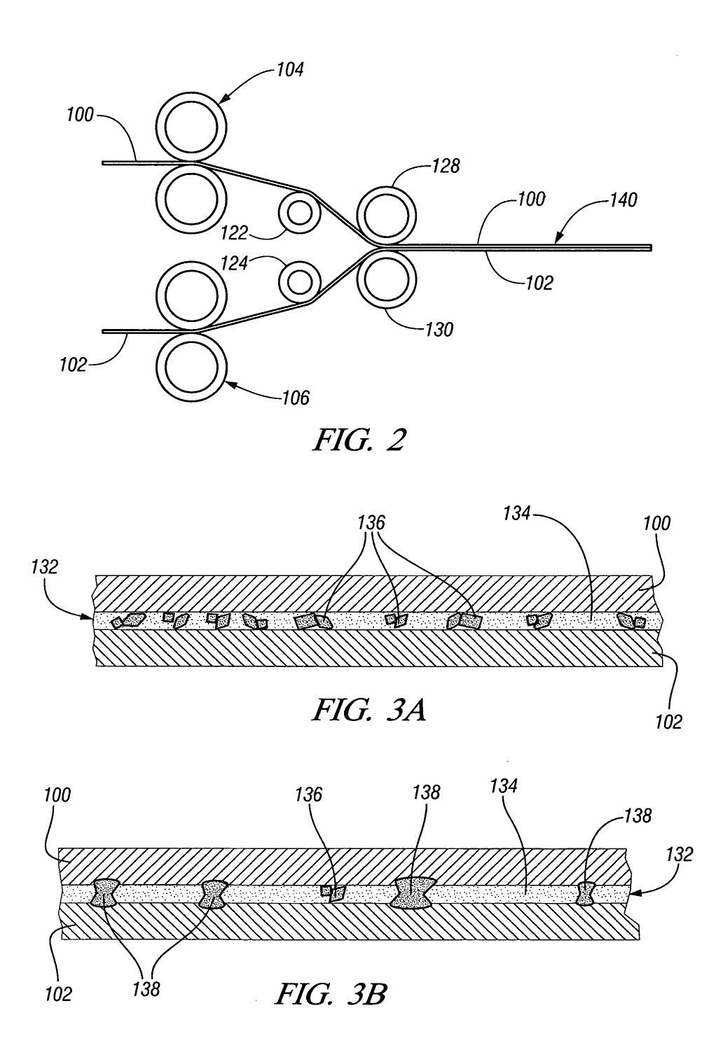

FIG. 2 illustrates a preferred method of making the laminate of this invention by a roll bonding process using continuous sheets 100 and 102 such as might be unwound from coils of hot and cold rolled low carbon steel or aluminum alloy. The process commences with the simultaneous and parallel feeding of annealed sheets 100 and 102 into rotary sheet alignment stands 104 and 106. Advancing sheets 100 and 102 are passed into contact with adhesive coating rolls 122, 124. A mobile thermoplastic or thermosetting adhesive material containing electrically conductive metal particles is applied as a coating film of suitable thickness. Roller application of the adhesive is illustrated in FIG. 2. But it is to be understood that the conductive particle-filled adhesive may alternatively be applied by other suitable processes such as painting or spraying.

The adhesive is applied in suitable thickness to sheets 100 and 102 (or at least one of them) over the entire facing surface areas of the advancing sheets. In this embodiment, both sheets 100, 102 are shown passing over adhesive coating rolls, but it will normally be sufficient to apply the particle filled adhesive to only one sheet. And in other embodiments of the invention, in which the conductive material is in the form of chopped wires or a wire mesh, the adhesive will preferably be applied to the lower sheet 102 and the wires or mesh applied to the adhesive coated surface.

The two sheets 100,102 with their respective adhesive coatings are brought together face-to-face and passed between bonding rolls 128, 130. Rolls 128, 130 apply pressure to push the adhesive coated sheets 100, 102 together and, thus, against the conductive particles. A voltage is applied between the bonding rolls 128, 130 from an electrical power source not shown. Because of the rotation of bonding rolls 128, 130, an electric current is caused to momentarily flow through each advancing increment of adhesive and conductive particles. In another embodiment of the invention, not illustrated in the drawing figures, two sets of rolls are used. A first set of rolls, that could be soft, are used to press the sheets together, and a second set of metal rolls are designed to pass the current through the advancing adhesive bonded sheets.

In still another embodiment of the invention, adhesive bonded laminate is cut into blanks. The blanks are placed successively between open flat platens of a press. The opposing platens are closed on the adhesive bonded sheet and voltage is applied between the platens to fuse the conductive element(s) to the facing sheets. The platens may be heated to facilitate curing or setting of the viscoelastic adhesive.

FIGS. 3A and 3B are enlarged schematic representations of fragments of sheets 100 and 102 with an adhesive core layer 132 of conductive particle-containing adhesive between them. Adhesive core layer 132 has an initially mobile thermoplastic or thermosetting adhesive composition vehicle 134 with dispersed particles of conductive metal 136. The pressure of rolls 128 and 130 spreads and evens the thickness of the adhesive vehicle phase between sheets 100, 102. The pressure of the rolls also closes the spacing between sheet 100, 102 to about the diameter or size of the particles 136 as seen in FIG. 3A. Typically, the sheets are quite thin, about 0.5 mm in this example. The thickness of the core layer 132 is usually less, for example about 0.1 mm.

The metal particles are quite small but present in sufficient abundance to permit initial current flow through the adhesive material between the sheets. The conductive particles partially or completely melt with current flow, wet the substrate, and locally melt the substrate forming small molten metal connections (ultimately solidifying as solid, electrically conductive, particulate bonding elements 138) between the bonded portions of mated sheets 100, 102. These molten connections or links then freeze to solid electrically conductive, particulate bonding elements 138 after the mated sheets 100, 102 move away from the rolls 128, 130 and the electric current flow in that portion of the sheets is stopped. As illustrated schematically in FIG. 3B, metallic particulate bonding elements 138 may have alloyed with and penetrated into the sheets 100, 102. Possibly, some of the original particles 136 may not have been fused to the facing sheets. The adhesive vehicle phase 134 can then be set or cured by heating the moving laminate strip 140 of bonded sheets 100, 102 through an oven, not shown, or other suitable heating device. Individual laminate blanks for panel forming or the like may then be trimmed from the roll of laminated material.

A key feature of this invention is the ability to obtain good long-term mechanical strength and electrical conductivity in the noise damping laminate material. The adhesive is by its very nature an insulator. To provide conduction and additional mechanical bonds between the confining sheets, conductive particles are placed in the adhesive. These would not ordinarily provide significant conduction since they are not in intimate contact with the substrate. Wetting the particles by the adhesive or degradation of particle or sheet surfaces would degrade conductivity, particularly over time. To solve this problem, the process is designed to form solid connections or links between the two sheets by melting the particles and then solidifying the molten material. Placing the sheet between rollers insures good electrical contact between many particles and the sheet. A voltage applied across the rolls or dies will then cause current to flow through the particles. The particles will melt, wet the sheet, and grow by alloying with the sheet. Following termination of the current, the molten areas will cool and solidify into multiple parallel links that provide many conduction paths between the two sheets.

Many suitable thermosetting viscoelastic adhesive compositions for sound and vibration damping composites are available. For example, epoxy resins, acrylic resins, and mixtures and copolymers of these resins are useful. The composition of the electrically conductive particulate material is preferably chosen based on the metal used in the sheets for the sound deadening laminates. It is preferred that the particulate material interacts with the sheet composition for melting of the particles, accumulation of good conductive paths or links, and the wetting of the sheet material for electrical conductivity after the molten mass from the particles re-solidifies.

As stated, the conductive particles used in the adhesive are usually selected based on the composition of the workpiece material. In this context, references to ferrous-based or aluminum-based workpiece materials, for example, usually mean that the principal metallic element represents half or more of the material to be adhesively bonded.

For ferrous-based sheet, such as carbon steel, the Fe—P intermetallics, Fe—C alloys or Fe—Si alloys, are usually suitable for the use in the conductive particles. Iron phosphides (Fe₃P and Fe₂P) have melting points below that of iron, and when they are molten form an alloy with iron (sometimes a eutectic alloy). Fe—C and Fe—Si alloys also have lower melting points than iron. Low melting point iron compounds or alloys, alone or mixed with iron, promote wetting of the steel surfaces. The diffusion of, e.g., carbon or phosphorus, into the ferrous workpiece lowers its melting point and melts/dissolves the substrate in the vicinity of the molten particle. Also particles composed of relatively low melting point Ni—P compositions may be used. The resultant molten metal that connects the two sheets provides a robust conduction path once it solidifies.

For aluminum-based sheet, Al—Si particles, preferably silicon-rich particles close to the Al—Si eutectic of 12.6% Si, are suitable conductive particles for incorporation into an adhesive. Silicon forms a low melting point eutectic with aluminum and the molten aluminum-silicon composition wets and dissolves into the aluminum sheet substrate to form a suitable electrical connection.

To obtain the most consistent, reproducible process the particle size should be closely controlled. Ideally, the particle size should correspond to the viscoelastic adhesive bond line thickness so that individual particles can singly bridge the gap between the two metal sheets. Less preferably, two or more particles in contact would bridge the gap between sheets.

The ideal conductive particle type would have several properties: low melting point relative to the substrate, good wetting of the substrate sheet, good electrical conductivity, good ductility or resistance to fracture when subjected to elastic stresses, and acceptable corrosion resistance.

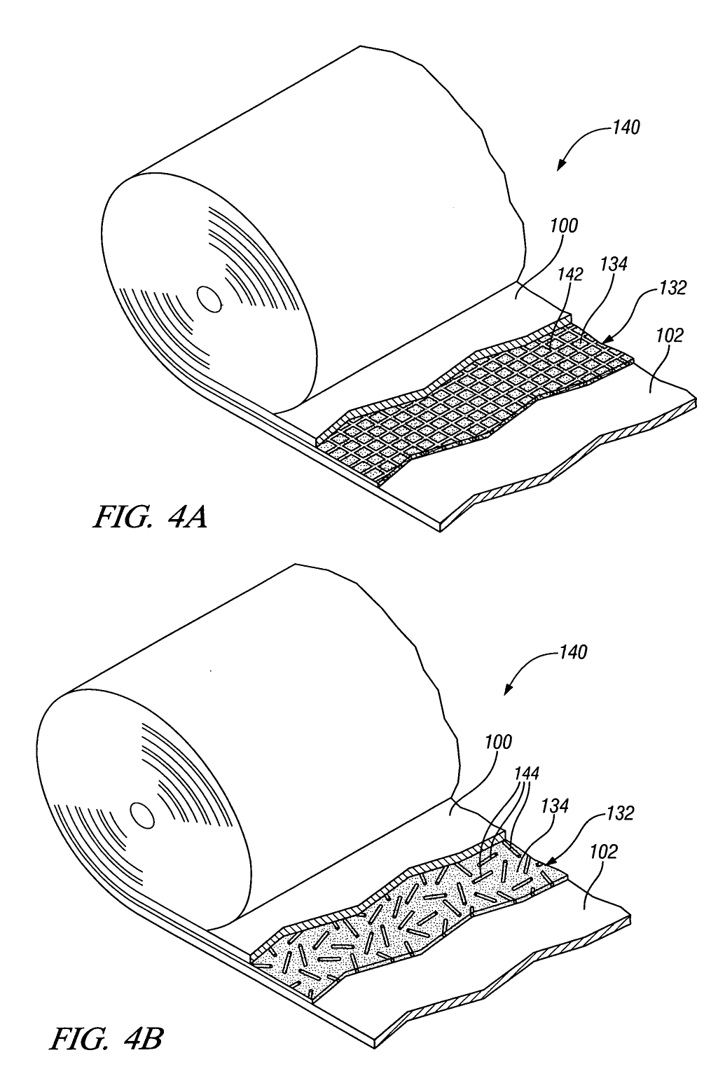

FIG. 4A illustrates another embodiment of the invention in which the conductive elements joining the facing surfaces of metal sheets 100 and 102 are the top and bottom surfaces of a wire mesh 142 immersed in the viscoelastic adhesive 134. Thus, the core layer 132 of the laminate 140 is formed by placing or laying a wire mesh 142 of suitably conductive material in the adhesive layer 134 after the adhesive has been applied to the upper surface of lower sheet 102 in a laminating practice similar to that illustrated in FIG. 2. After sheets 100, 102 have been pressed together an electric current is passed between them as in the particle filled adhesive embodiment of FIG. 2. The heating is conducted so that the top and bottom surfaces of the wire mesh 142 fuse to the facing surfaces of sheets 100, 102 in the same manner as particulate bonding elements 138 are formed in the embodiment of FIG. 3B. The placing of the wire mesh in the coated adhesive layer on the metal sheet requires careful mechanical manipulation. But the uniform spacing of the parallel and perpendicular wires in the mesh provides uniform bonding between the sheets with ample remaining damping area for the adhesive.

FIG. 4B illustrates still another embodiment of the invention in which the conductive elements joining the facing surfaces of metal sheets 100 and 102 are the top and bottom surfaces of uniformly placed chopped wires 144 immersed in the viscoelastic adhesive 134. Again, the core layer 132 of the laminate 140 is formed by carefully laying chopped wires of suitably conductive material on the adhesive layer 134 after the adhesive has been applied to the upper surface of sheet 102. After sheets 100, 102 have been pressed together; an electric current is passed between them as in the particle filled adhesive embodiment of FIG. 2. The heating is conducted so that the top and bottom surfaces of the wires 144 fuse to the facing surfaces of sheets 100, 102 in the same manner as particulate bonding elements 138 are formed in the embodiment of FIG. 3B. The placing of the wires on the coated adhesive layer on the metal sheet requires careful mechanical manipulation. But the spacing of the wires provides uniform bonding between the sheets with ample remaining damping area for the adhesive.

The composition of the chopped wires or of the wire mesh is coordinated, as described with respect to conductive particles, with the composition of the facing sheets to enable fused bonding between the wires and the sheets.

The practice of the invention has been described in terms of a few preferred embodiments but the scope of the invention is limited only by the following claims.

1. A composite layered sheet metal structure for sound or vibration damping comprising:
a first metal sheet with a first bonding surface;
a second metal sheet with a second bonding surface co-extensive with and facing the first bonding surface; and
an interlayer comprising an adhesive bonding the first and second bonding surfaces, the interlayer further comprising electrically conductive bonding elements fused to each of the bonding surfaces and providing a plurality of mechanical bonds and electrical flow paths through the adhesive from the first bonding surface to the second bonding surface.

2. A composite layered structure as recited in claim 1 in which the electrically conductive bonding elements are in the form of particles, wires, or meshes of wires.

3. A composite layered structure as recited in claim 1 in which electrically conductive bonding elements are in the form of particles, wires or wire meshes; the bonding elements are of a composition comprising a metallic element; and the size or thickness of the bonding elements is substantially the thickness of the adhesive bond to be formed between the first and second bonding surfaces.

4. A composite layered structure as recited in claim 1 in which the first and second metal sheet members are each of the same base metal alloy and the electrically conductive bonding elements are of a composition comprising the base metal element.

5. A composite layer structure as recited in claim 1 where the first and second metallic members are ferrous-based members and the adhesive contains distributed particles that comprise a composition selected from the group consisting of iron-silicon intermetallic compounds, iron-phosphorus intermetallic compounds, nickel-phosphorus intermetallic compounds, and alloys of iron-phosphorus, iron-silicon, iron-carbon, and nickel-phosphorus.

6. A composite layer structure as recited in claim 1 where the first and second metallic members are aluminum-based members and the adhesive contains distributed particles that comprise a composition selected from the group consisting of aluminum-silicon compositions.
